(19) United States
(12) Patent Application Publication
(10) Pub. No.: US 2022/0382775 A1
(43) Pub. Date: Dec. 1, 2022

(54) EMPLOYEE COMPENSATION MANAGER

(71) Applicant: Zinkt Inc., Toronto (CA)

(72) Inventors: Michael Zaranyik, Toronto (CA); Thomas Francis Edward Swinbourne, Birmingham (GB); Matthew James Williams, Oakville (CA)

(73) Assignee: Zinkt Inc., Toronto (CA)

(21) Appl. No.: 17/303,512

(22) Filed: Jun. 1, 2021

(51) Int. Cl. G06F 16/25; G06Q 40/00

(52) U.S. Cl. CPC G06F 16/258; G06Q 40/12

(57) ABSTRACT

An example of an apparatus is provided. The apparatus includes a database management system. In addition, the apparatus includes a first database maintained within the database management system. Furthermore, the apparatus includes an aggregator to identify a targeted data record in the first database based on a predetermined commissionable event. The targeted data record stores a metric associated with the predetermined commissionable event. The apparatus further includes a normalization engine to normalize the targeted data record to create a standardized data record. Also, the apparatus includes a second database maintained within the database management system to store the standardized data record. The second database is accessible to a sales agent based on granted permissions. In addition, the apparatus includes a communications interface to transmit the standardized data record and a command to an external service. The external service is to execute the command to process the standardized data record.

### BACKGROUND

Businesses operate by interacting with clients of customers. Information about clients and customers, including former, present and prospective clients and customers, may be collected, stored and managed by a customer relationship management system. It is known that a customer relationship management system may collect and compile a vast amount of data associated with each client or customer including current information available online, communications with the client or customer. For example, data relating to the amount of client interaction as well as the client's preferences for communication may be stored. The data via various methods such as surveys or data collected from interactions with the client or customer. Accordingly, the customer relationship management system may maintain data for each client or customer of the business including past sales data, marketing efforts, contacts with employees and contractors, such as sales agents and other data.

In addition, a business may employ different people who receive compensation that may vary. The varying compensation may be based on various performance metrics, such as sales and/or revenue data for a sales agent or number of tickets resolved for a IT support personnel. Accordingly, an incentive compensation management system may be used to manage the compensation to an employee, contractor, or any other person receiving variable compensation.

To interact with the clients of customers of the business, sales agents are often used as the main point of contact. Data relating to the interactions involving different sales agents may also be stored in the customer relationship management system. Sales agents are generally compensated based on an incentive model. Various metrics may be used to determine a compensation amount based various performance metrics, such as total sales, sales effectiveness, new business leads, and other metrics.

### BRIEF DESCRIPTION OF THE DRAWINGS

Reference will now be made, by way of example only, to the accompanying drawings in which:

FIG. 1 is a block diagram of an example apparatus to create standardized data and a processing command;

FIG. 2 is a block diagram of another example apparatus to create standardized data and a processing command;

FIG. 3 is a diagram of an example system to determine a compensation amount using the standardized data and a processing command from the apparatus shown in FIG. 2; and

FIG. 4 is a flowchart of an example method of creating standardized data and a processing command.

### DETAILED DESCRIPTION

Database management systems are used by businesses and organizations to collect, store, and extract useful information. The data stored in a database management system is not particularly limited and may include data associate with all aspects of the business. In one example, the data may include customer relationship data to track various metrics associated with a customer with whom the business or organization has a connection. The connection may be a relationship where the business is carried out with the customer on a regular or periodic basis. Another relationship type may that there was a former business relationship or the relationship may be one where the customer is a prospective customer. The data collected may include a wide variety of data, such as sales data, marketing efforts, contacts with employees and contractors, such as sales agents and other data for existing and former customers. Such data may be used to increase sales and/or target advertising to existing and former customers. In particular, the data may provide information that can be used to evaluate the success of various marketing efforts and campaigns. For prospective customers, the data may be collected from publicly available sources as well as through targeted surveys and used to design marketing campaigns to convert the prospective customer to an existing customer.

In many examples, the data associated with each customer includes data about the interactions with the customer. In some instances, the interactions are automated, such as sending periodic advertisements to a customer list via mail, email, or other forms of communication. In other instances, the interactions may include interactions between a sales agent and customer such as a phone call, email communication, or in-person meeting. The data may include the details of each interaction and track the sales agent involved with the interaction. Furthermore, each contract or sale may be linked with a specific sales agent to provide data that may be used to evaluate the performance of the sales agent.

It is to be appreciated by a person skilled in the art with the benefit of this description that the database management system may be configured to organize data in a specific manner to provide information. In the above example where the database management system is a customer relationship management system, the data is organized to store data in data records associated with a customer. This provides for easy retrieval of information associated with the customer or group of related customers to be used to develop marketing campaigns and business development strategies that would be predicted to be effective for the customer or group of customers. In addition to improving interactions with customers, the business or organization typically compensates some employees and contractors, such as sales agents based on performance. In particular, various metrics may be used to evaluate the performance of a sales agent.

An apparatus and associated method to process targeted data records to execute commands and actions based on the data records is provided. In the present example, the data records are store in a database management system, such as a customer relationship management system. The relevant data records are processed to generate standardized data which may be transmitted along with a command to an external service for additional processing. In particular, the targeted data records may be records associated with an employee or contractor, such as a sales agent, such records associated with a customer with whom the sales agent has had an interaction. The data records may be normalized to extract the relevant information and combined along with a command to the external service, which may be a sales performance management system or an incentive compensation management system. The command is not particularly limited, but may be a command to process a compensation payment based on an automated determination based on the metrics.

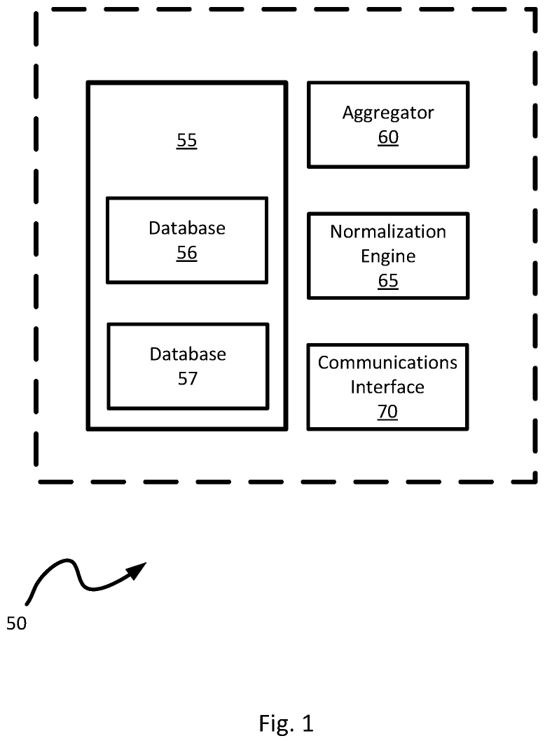

Referring to FIG. 1, an example of an apparatus to create standardized data and a processing command is generally shown at 50. The apparatus 50 may include additional components, such as various memory storage units, additional interfaces to communicate with other devices, and further input and output devices to interact with a user or an administrator of the apparatus 40. In addition, the apparatus 50 may be separated into multiple components operating as a system as described in greater detail below. In some examples, the components may be distributed across multiple locations and operate as a cloud service. In the present example, the apparatus 50 includes a database management system 55, an aggregator 60, a normalization engine 65, and communications interface 70. Although the present example shows the aggregator 60 and the normalization engine 65 as separate components, in other examples, the aggregator 60 and the normalization engine 65 may be part of the same physical component such as a microprocessor configured to carry out multiple functions.

The database management system 55 is to maintain various databases, each database having a plurality of data records. The databases are not particularly limited and may include a wide variety of different types of data records. In the present example, the database management system 55 is a customer relationship management system, such as SAP, ORACLE, or SALESFORCE.

In the present example, it may be assumed that the employee or contractor is a sales agent representing the company and that the database 56 is maintained within the database management system 55. Continuing with the present example where the database management system 55 is a customer relationship management system, the database 56 may store a plurality data records where each data record is associated with a customer. Some of the data records associated with existing customers includes information about interactions with the customer. For example, the data records may include the identification of a sales agent associated with the customer. In some examples, a customer may be associated with more than one sales agent. The data record may also include raw sales data, opportunity data, or other financial information including expenses and other costs associated with the customer. For customers with more than one associated sales agent, the financial information, such as revenue and costs, may be divided amount the sales agents. It is to be appreciated by a person of skill in the art with the benefit of this description that the manner by which the financials are divided among sales agents are not particularly limited and may be predetermined by the administrator of the apparatus.

In some examples, the database 56 may not be accessible to a sales agent. In particular, the data records stored in the database 56 may include confidential and proprietary information that would be accessible by an administrator or other user with appropriate credentials.

An additional database 57 is also maintained within the database management system 55. In the present example, the database 57 is configured to store standardized data records created by the normalization engine 65. The database 57 may store a plurality data records where each data record is distilled to remove any information that is not intended to be accessible by the sales agent. Accordingly, sales agents may be provided with access to the database 57 in its entirety or portions of the database 57 associated with the sales agent requesting access. It is to be appreciated by a person of skill in the art with the benefit of this description that the amount of access provided to a sales agent may be based on the granted permissions to the sales agent by an administrator. The manner by which access to the database 57 is provided to the sales agent with the appropriate permissions is not limited. In the present example, a request for a data record from the database 57 may be received via the communications interface 70 from a user device of the sales agent. The requested data record from the database 57 will then be transmitted back to the user device from which the request originated.

In other examples, a sales agent may subscribe to a periodic update of a data record from the database 57. In this example, the data record from the database 57 may be transmitted to the user device of the sales agent periodically, such as daily, weekly or monthly. It is to be appreciated by a person of skill with the benefit of this description that by providing periodic updates, the sales agent may be able to continuously review their own performance and verify that performance metrics are properly documented prior to sending to an external service to process a compensation payment.

The data records stored in the database 57 are to be associated with a sales agent. The data records may include normalized data distilled from a data record in the database 56 associated with each sales agent in a format for exporting to the external service. The format of the data records is not particularly limited and may be in an industry accepted format or in a format compatible with the external service to which the data is to be transmitted. The data record may also include raw sales data or other financial information including expenses and other costs associated with a sales agent. For sales agents assigned to more than one customer, the standardized data record may include normalized data from more than one data record in the database 56.

The aggregator 60 is to identify a data record in the database 56 based on a predetermined commissionable event. The commissionable event is not particularly limited and may be set by the business or organization for which the sales agent is employed. In some examples, a commissionable event may be a sale or revenue generating event. In other examples, a commissionable event may include customer introductions or other event.

Once the commissionable event has been identified, the aggregator retrieves the data record or portions of the data record from the database 56 associated with the commissionable event. The data record in the database 56 may include data such as metrics associated with the commissionable event. In one example, the metric may be the amount of revenue attributed to the sales agent.

In examples where a sales agent is associated with multiple data records in the database 56, the aggregator 60 may identify each of the data records with a commissionable event. It is to be appreciated with the benefit of this description that not all data records associated with the sales agent may include a commissionable event. For example, if the commissionable event is the generation of an invoice to a customer, a customer associated with a sales agent may not have any generated invoices. Accordingly, the data record of this customer would not be selected by the aggregator 60. Furthermore, the aggregator 60 may distill the data from the data record associated with the commissionable event. Continuing with the present example, if the data record includes data associated with the generation of an invoice and other information, such as meeting data, the aggregator 60 may retrieve the data associated with the generation of an invoice while leaving the meeting data alone. Accordingly, the amount of data to be retrieved will be less as irrelevant data in the data record is not transferred.

The normalization engine 65 is to normalize the data record in the database 56 that was identified by the aggregator 60 to include a commissionable event. The manner by which the data record in the database 56 is normalized is not particularly limited. In the present example, the data record in the database 56 is distilled to extract information relevant to the commissionable event to create a standardized data record to be stored in the database 57. The format of the standardized data record is not particularly limited and may be in a format provided by the external service to which the standardized data record is to be sent. For example, the normalization engine 65 may encode the data such that a command to process the information in the standardized data record are combined into a single file or data transfer.

The standardized data record to be stored in the database 57 includes data associated with an employee or a contractor, such as a sales agent. Accordingly, each standardized data record may include an identifier of the sales agent. Furthermore, as mentioned above, each sales agent may be associated with more than one data record in the database 56. The normalization engine 65 may further be used to group data from multiple data records from the database 56. For each data record from the database 56, the normalization engine 65 will normalize the data record. The normalization engine 65 may match sales agent identifiers in the normalized data to generate a single standardized data record for each sales agent.

The communications interface 70 is to communicate with other devices or services over a network. In particular, the communications interface 70 is to transmit the standardize data record to an external service with a command to process the information in the standardized data record. It is to be appreciated that the communications interface 70 may also connect with additional devices such as user devices of the sales agents or additional external services. Accordingly, the exact number of devices with the communications interface 70 communicates is not limited. The manner by which the communications interface connects devices to the apparatus 50 is not limited and may include different types networks. Furthermore, it is to be appreciated that the communications interface 70 may be configured receive data as well, such as data from the external service in response to the transmission of the standardized data record.

The manner by which the communications interface 70 transmits and/or receives data is not particularly limited. In the present example, the apparatus 50 may connect to devices via a network link. Accordingly, the communications interface 70 may be a network interface communicating over the Internet. In other examples, the communication interface 70 may directly connect to the devices via a wire or other direct communication link, such as a via a local area network, when the devices are to be confined to a limited geographical area.

Various advantages will now be apparent to a person of skill in the art with the benefit of the present description. For example, by aggregating the data from the database 56 and normalizing the data records from the database 56 within the apparatus, the apparatus 50 may communicate directly with an external service without using any intermediary service or device to distill the data from the database 56. In particular, by packaging the data and storing the aggregated and distilled data in the database 57, the data remains secure at all times within the apparatus 50. Furthermore, by allowing sales agents to access the database 57, each sales agent is able to review and verify the information that was retrieved from the database 56 allowing the sales agent to bring forward concerns prior to transmitting the standardized data record to the external service. In the above example, the database management system 55 is a customer relationship management system and the standardized data record includes performance metrics. In turn, the standardized data record may be verified by the sales agent prior to being transmitted to an external service to determine where a compensation payment may be made to the sales agent. It is to be appreciated by a person skilled in the art with the benefit of this description that by addressing concerns prior to transmitting the standardize data record to the external service, the issues may be addressed without involving additional corrections at the external service if additional processing steps have started based on the standardized data. The manner by which the issues are addressed is not particularly limited and may involve the sales agent correcting the data, or may involve making a request to a supervisor with sufficient rights to modify the data. Accordingly, the apparatus 50 provides for a streamlined process to maintain customer data in the database 56 and generate sales agent data to be stored in the database 57.

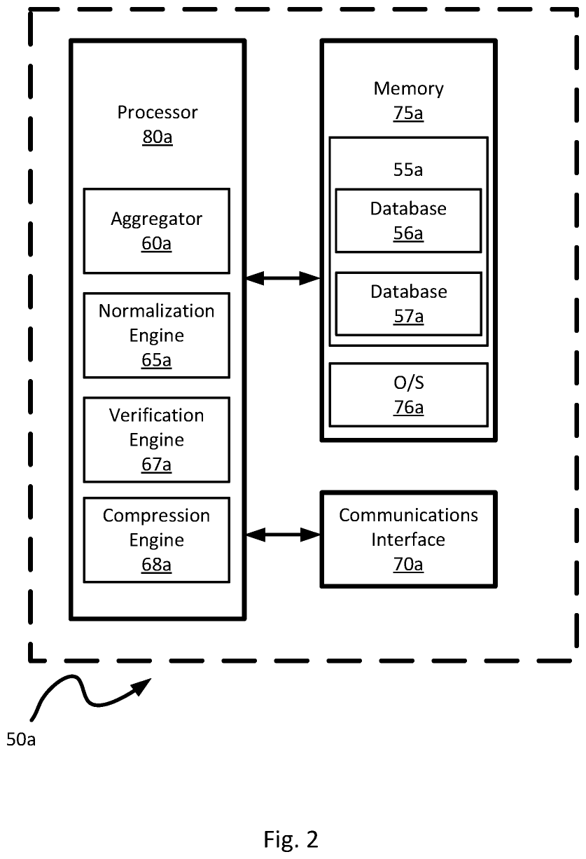

Referring to FIG. 2, another example an apparatus to create standardized data and a processing command is generally shown at 50a. Like components of the apparatus 50a bear like reference to their counterparts in the apparatus 50, except followed by the suffix “a”. The apparatus 50a includes a communications interface 70a, a memory storage unit 75a, and a processor 80a. In the present example, an aggregator 60a, a normalization engine 65a, a verification engine 67a and a compression engine 68a are implemented by the processor 80a. Furthermore, the database management system 55a is maintained in the memory storage unit 75a.

In the present example, the memory storage unit 75a is to store various data and information on the apparatus 50a. The memory storage unit 75a is not particularly limited and may include various types of computer memory devices. For example, the memory storage unit 75a may include a non-transitory machine-readable storage medium that may be, for example, an electronic, magnetic, optical, or other physical storage device. In the present example, the database management system 55a is maintained in the memory storage unit 75a. In addition, the memory storage unit 75a may store an operating system 76a that is executable by the processor 80a to provide general functionality to the apparatus 50a. The operating system 76a is not particularly limited and may include WINDOWS, MACOS, 10S, ANDROID, LINUX, and UNIX. in addition, the memory storage unit 75a may additionally store instructions to operate peripheral devices at the driver level of the apparatus 50a, such as to operate the communications interface 70a.

The database management system 55a is not particularly limited and functions similar to the database management system 55 described above. In particular, the database management system 55a includes the database 56a, which may store customer data records in a customer relationship management system, such as SAP, ORACLE, or SALESFORCE. The database management system 55a also includes the database 57a, which may store standardized data records associated with sales agents.

The processor 80a may include a central processing unit (CPU), a graphics processing unit (GPU), a microcontroller, a microprocessor, a processing core, a field-programmable gate array (FPGA), an application-specific integrated circuit (ASIC), or similar. The processor 80a and the memory storage unit 75a may cooperate to execute various instructions, such as for the processor 80a to carry out operations in the database management system 55a or for the processor 80a to be directed by instructions store in the memory storage unit 75a. In particular, the processor 80a may execute instructions stored on the memory storage unit 75a to implement the aggregator 60a, the normalization engine 65a, the verification engine 67a and the compression engine 68a.

Although the present example shows the processor 80a implementing the aggregator 60a, the normalization engine 65a, the verification engine 67a and the compression engine 68a, it is to be appreciated by a person of skill with the benefit of this description that variations are contemplated. For example, the aggregator 60a, the normalization engine 65a, the verification engine 67a and the compression engine 68a may be implemented on multiple processors. In this example, each of the aggregator 60a, the normalization engine 65a, the verification engine 67a and the compression engine 68a may be operated on separate processor within the apparatus 50a. In further examples, the aggregator 60a, the normalization engine 65a, the verification engine 67a and the compression engine 68a may be operated on a separate machine, such as from a software as a service provider or in a virtual cloud server.

The aggregator 60a and the normalization engine 65a is not particularly limited and function similar to the aggregator 60 and the normalization engine 65 described above, respectively.

In the present example, the apparatus 50a further includes a verification engine 67a implemented by the processor 80a. The verification engine 67a is not particularly limited and provides the ability to verify the identity of a sales agent. The database 57a is to be accessible to a sales agent with the proper credentials. Accordingly, if the sales agent request access to a standardized data record in the database 57a, the request may be processed to by the verification engine 67a to confirm the identity of the sales agent. The manner by which the request is verified is not particularly limited. For example, the verification engine 67a may prompt a requester for a username and password upon receiving a request for a standardized data record. In other examples, the request may include verification data collected by the device of the sales agent. The verification data may include biometric data. Further examples, may include a verification engine 67a using multi-factor verification processes, such as a token system.

The compression engine 68a is to combine the standardized data record and the command to be send to the external service. The manner by which the compression engine 68a packages the standardized data record and the command is not particularly limited. For example, the standardized data record and the command may be compressed into a single file that may also be executable by the external service.

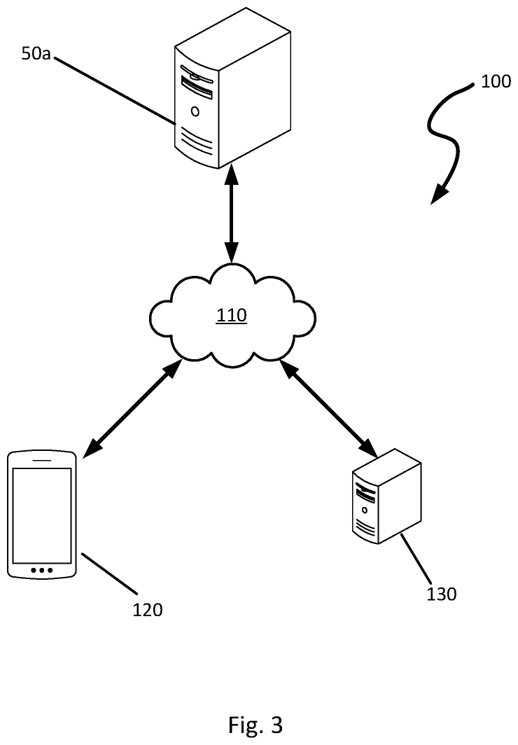

Referring to FIG. 3, an example of a sales agent compensation system is generally shown at 100. In the present example, the apparatus 50a is in communication with a sales agent device 120 and an external service 130 via a network 110. It is to be appreciated that the sales agent device 120 and the external service 130 are not limited and variations capable of performing the design functions may be substituted. Furthermore, although the present example illustrates a single sales agent device 120 and a single external service 130, additional devices may be added to the system 100. In particular, a business or organization operating the system 100 may have multiple sales agents each with a separate sales agent device 120. Similarly, the apparatus 50a may include multiple databases storing standardized data records with different metrics to be sent to different external service 130.

The sales agent device 120 may be any type of electronic device used by a sales agent to access a standardized data record. Some examples of devices that may be used as a sales agent device 120 are a smartphone, a tablet, a laptop, a desktop computer, or any other device capable of receiving user input to and generating user output. The sales agent device 120 includes its own communications interface, and processor. The sales agent device 120 may also include input, such as a keyboard, pointer, and or touchscreen, and/or output devices such as a display or touchscreen display. For example, the sales agent device 120 may be preload with an application to provide a convenient user interface from which the sales agent can request information in the standardized data record and display the information in a user friendly format.

The external service 130 is to receive the standardized data record along with a command to process the data record. In the present example, the external service 130 is a sales performance management system. Accordingly, the external service 130 is to receive metrics associated with the sales agent and to execute the command to process the metrics. In this example, the command may direct the external service 130 to calculate and/or make a payment to the sales agent as compensation. The external service 130 may also be in communication with a banking institution or accounting system to provide the sales agent with compensation based on the standardized data record.

As another example, the external service 130 may be a scheduling service configured to schedule meetings for a sales agent based on the standardized data record which includes information to prioritize meetings with customers to improve the impact of each meeting. In this example, the information in the standardized record may include time interval from the last meeting between the customer and the sales agent and outcome of the meeting, such as the amount of revenue that can be attributed to the meeting. In addition, the external service 130 may receive multiple standardized data records, each associated with a different sales agent, to select the match the most effective sales agent with a customer.

Upon processing the standardized data record, the external service 130 may generate compensation data. The compensation data is not particularly limited and may include an amount of compensation to be paid to the sales agent associated with the data record. The compensation data may also include details of the payment and/or verification of the transfer. The compensation data may then be transmitted from the external service 130 to the apparatus 50a via the network 110. The apparatus 50a may store the compensation data in the database management system 55a to maintain a historical record of compensation for the sales agent. In some examples, the compensation data may also be combined with the standardized data record associated with the sales agent to provide updated information to be stored in the database 57a. Accordingly, the database management system 55a may reconcile data with the external service 130 and vice versa.

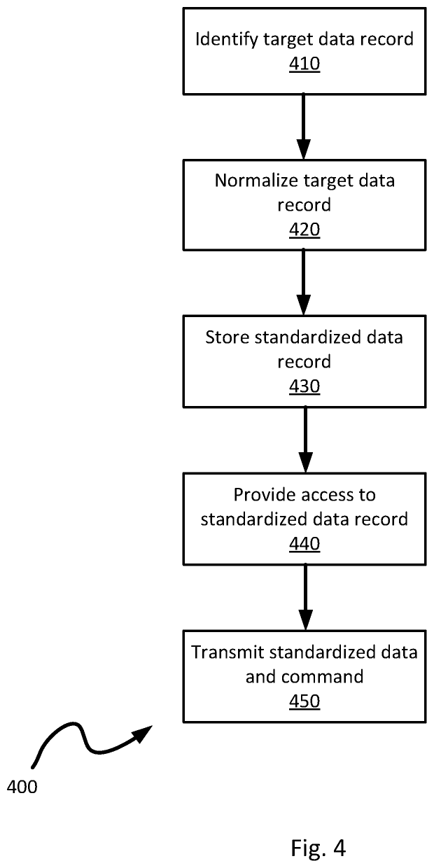

Referring to FIG. 4, a flowchart of an example method of creating standardized data and a processing command to be transmitted to an external service is generally shown at 400. In order to assist in the explanation of method 400, it will be assumed that method 400 may be performed by the apparatus 50a in the system 100. Indeed, the method 400 may be one way in which the apparatus 50a may be configured. Furthermore, the following discussion of method 400 may lead to a further understanding of the system 100 and it components. In addition, it is to be emphasized, that method 400 may not be performed in the exact sequence as shown, and various blocks may be performed in parallel rather than in sequence, or in a different sequence altogether.

Beginning at block 410, a data record in the database 56a is identified based on a predetermined commissionable event. In the present example, the commissionable event is not particularly limited and may be set by the business or organization for which a sales agent is employed. The data record in the database 56a may include data such as metrics associated with the commissionable event.

Block 420 comprises normalizing the data record in the database 56a that was identified at block 410. In the present example, the data record in the database 56a is distilled to extract information relevant to the commissionable event to create a standardized data record to be stored in the database 57a at block 430.

Block 440 provides a sales agent with access to a standardized data record stored in the database 57a. It is to be appreciated by a person skill in the art that in the present example, the sales agent does not have access to the database 56a, which may include additional information that the sales agent should not have access to.

The manner by which access is provided is not particularly limited. In the present example, a sales agent may be prevented from accessing the standardized data record unless the sales agent has been granted permission. The access may be provided upon receiving a request from the sales agent. In some examples, the request may include information to verify the authenticity of the request from the sales agent. In other examples, the standardized data record may be periodically sent to the sales agent, such as via email.

Block 450 involves transmitting the standardized data record and a command to an external service 130. The external service 130 may then execute the command to process the standardized data record further. The manner by which the external service 130 processes the standardized data record is not particularly limited. For example, the external service 130 may use the standardized data record to calculate a compensation amount for a sales agent and process the payment through a financial institution automatically.

The manner by which the standardized data record and the command are transmitted to the external service 130 is not particularly limited. For example, the standardized data record and the command may be encoded into a single file that can be processed by the external service 130. In some examples, the file may be an executable file. In addition, the standardized data record and the command may be compressed to reduce the amount of data to be transmitted and thus increase the speed and efficiency of the system 100.

It should be recognized that features and aspects of the various examples provided above may be combined into further examples that also fall within the scope of the present disclosure.

What is claimed is:

1. An apparatus comprising:
a database management system;
a first database maintained within the database management system;
an aggregator to identify a targeted data record in the first database based on a predetermined commissionable event, wherein the targeted data record stores a metric associated with the predetermined commissionable event;
a normalization engine to normalize the targeted data record to create a standardized data record;
a second database maintained within the database management system, the second database to store the standardized data record, wherein the second database is accessible to a sales agent based on granted permissions; and
a communications interface to transmit the standardized data record and a command to an external service, wherein the external service is to execute the command to process the standardized data record.

2. The apparatus of claim 1, wherein the database management system is a customer relationship management system.

3. The apparatus of claim 2, wherein the first database stores raw sales data associated with a customer record in the targeted data record.

4. The apparatus of claim 1, wherein the standardized data record is associated with the sales agent.

5. The apparatus of claim 4, wherein the standardized data record includes normalized data from a plurality of targeted data records.

6. The apparatus of claim 5, wherein the communications interface is to receive a request for the standardized data record from a user device associated with the sales agent.

7. The apparatus of claim 6, further comprising a verification engine to verify the request.

8. The apparatus of claim 5, wherein the communications interface is to transmit the standardized data record to a user device associated with the sales agent periodically.

9. The apparatus of claim 1, further comprising a compression engine to combine the standardized data record and the command into a file for transmission.

10. The apparatus of claim 1, wherein the communications interface is to receive compensation data from the external service, the compensation data to be stored in the database management system.

11. A method comprising:
identifying, based on a predetermined commissionable event, a targeted data record in a first database in a data management system, wherein the targeted data record stores a metric associated with the predetermined commissionable event;
normalizing the targeted data record to generate a standardized data record;
storing the standardized data record in a second database of the data management system;
providing access to the second database to a sales agent based on granted permissions; and
transmitting the standardized data and a command to an external service, wherein the external service is to execute the command to process the standardized data.

12. The method of claim 11, further comprising associating the standardized data record with the sales agent.

13. The method of claim 12, further comprising transmitting the standardized data record to the sales agent upon receiving a request.

14. The method of claim 13, further comprising verifying the request.

15. The method of claim 11, further comprising combining the standardized data record and the command into a file to transmit to the external service.

16. A non-transitory machine-readable storage medium encoded with instructions executable by a processor, the non-transitory machine-readable storage medium comprising:
instructions to identify, based on a predetermined commissionable event, a targeted data record in a first database in a data management system, wherein the targeted data record stores a metric associated with the predetermined commissionable event;
instructions to normalize the targeted data record to generate a standardized data record;
instructions to store the standardized data record in a second database of the data management system;
instructions to provide access to the second database to a sales agent based on granted permissions; and
instructions to transmit the standardized data and a command to an external service, wherein the external service is to execute the command to process the standardized data.

17. The non-transitory machine-readable storage medium of claim 16, comprising instructions to associate the standardized data record with the sales agent.

18. The non-transitory machine-readable storage medium of claim 17, comprising instructions to transmit the standardized data record to the sales agent upon receiving a request.

19. The non-transitory machine-readable storage medium of claim 18, comprising instructions to verify the request.

20. The non-transitory machine-readable storage medium of claim 16, comprising instructions to combine the standardized data record and the command into a file for transmitting to the external service.
